(19) United States
(12) Patent Application Publication
(10) Pub. No.: US 2016/0116213 A1
(43) Pub. Date: Apr. 28, 2016

(54) DRYING TRAILER

(71) Applicant: PeerSouth, Inc., Shellman, GA (US)

(72) Inventors: William E. Dykes, JR., Marietta, GA (US); Henry Harold Griffin, Leesburg, GA (US); David M. Rogers, Dawson, GA (US); Larry W. Nichols, Dawson, GA (US)

(21) Appl. No.: 14/524,632

(22) Filed: Oct. 27, 2014

(51) Int. Cl. F26B 25/06; B62D 25/20; B62D 65/00

(52) U.S. Cl. CPC F26B 25/063; B62D 65/00; B62D 25/2054; B62D 25/2036

(57) ABSTRACT

An elevated flooring system for use in a drying trailer including a truss, a bottom surface of the truss fixedly attachable to a trailer floor of the drying trailer; a drying floor including a floor panel defining openings sized to allow passage of drying air, the floor panel lying on the truss and separable from the truss, the truss sized to elevate the drying floor a spaced distance from the trailer floor; and a support attachable to a side wall of the drying trailer, the drying floor detachably connected to the support.

### TECHNICAL FIELD

This disclosure relates to bulk drying of materials. More specifically, this disclosure relates to portable systems and methods for drying and transporting goods such as agricultural or other fungible products.

### BACKGROUND

In numerous situations involving the processing of goods such as the harvesting of agricultural products, it can be advantageous and in some cases necessary to dry those goods in order to reduce or eliminate the growth of undesirable organisms such as mold, to facilitate the cleaning of the materials, to reach a desirable moisture content, or to otherwise prepare the materials for further processing before shipment, sale, or use. Example applications for such a drying process include the drying of food items such as peanuts and non-food items such as wood chips.

Because traditional systems and methods for drying goods, including fungible products that are typically harvested in an outdoor environment and not in a manufacturing plant, have limited usefulness in that they are typically used for drying or only for storing or only for unloading. For example, a user is often required to purchase or lease additional equipment to perform other steps that are required in order to process the products, such as to store the products including transport of the products.

### SUMMARY

Disclosed is an elevated flooring system for use in a drying trailer including a truss, a bottom surface of the truss fixedly attachable to a trailer floor of the drying trailer; a drying floor including a floor panel defining openings sized to allow passage of drying air, the floor panel lying on the truss and separable from the truss, the truss sized to elevate the drying floor a spaced distance from the trailer floor; and a support attachable to a side wall of the drying trailer, the drying floor detachably connected to the support.

Also disclosed is a drying trailer including a trailer body, the trailer body including a lower floor, a first side wall, a second side wall, and a front wall; a truss, a bottom surface of the truss fixably attached to the lower floor of the trailer body of the drying trailer; at least one floor panel defining a drying floor, the floor panel defining openings sized to allow passage of drying air, the floor panel lying on the truss and separable from the truss, the truss elevating the drying floor a spaced distance from the lower floor, an air circulation cavity defined between the drying floor, the lower floor, the first side wall, and the second side wall.

Also disclosed is a method of converting a drying trailer from a drying state to a storage state including: disconnecting a floor panel from a support within a drying trailer, the drying trailer having a truss and a trailer floor, the floor panel lying on the truss, the truss sized to elevate the drying floor a spaced distance from the trailer floor; and moving the floor panel away from the truss; and removing the floor panel from an interior of the drying trailer to an exterior of the drying trailer.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures may be designated by matching reference characters for the sake of consistency and clarity.

FIG. 1 is a perspective view of one embodiment of a drying trailer with a chassis frame that is attachable to a truck.

FIG. 2a is a perspective view of a second embodiment of a chassis frame of the drying trailer of FIG. 1.

FIG. 2b is a detailed perspective view of the chassis frame of FIG. 2a as shown by detail 2b in FIG. 2a.

FIG. 3 is a perspective bottom view of the chassis frame of FIG. 2a attached to a trailer body of the drying trailer of FIG. 1.

FIG. 4 is a bottom view of the drying trailer of FIG. 3 without a full chassis.

FIG. 5 is a side view of the trailer body of the drying trailer of FIG. 3.

FIG. 6 is a rear view of the trailer body of FIG. 5 with a rear gate of the drying trailer removed.

FIG. 7 is a perspective top view of the trailer body of FIG. 5.

FIG. 8 is a detail perspective top view of the trailer body of FIG. 5 taken from detail 8 in FIG. 7.

FIG. 9 is a perspective view of a rear portion of the trailer body of FIG. 5 with a floor panel removed.

FIG. 10 is a detail perspective view of the trailer body of FIG. 5 taken from detail 10 of FIG. 9.

FIG. 11a is a detail rear view of a lower portion of the trailer body of FIG. 5 taken from detail 11a in FIG. 6.

FIG. 11b is a detail rear view of a truss of the lower portion of the trailer body of FIG. 5 after removal of surrounding structure shown in FIGS. 5 and 11a.

FIG. 12 is a detail sectional view of the interaction between a drying floor and a right side wall of the trailer body of FIG. 2 taken from detail 12 of FIG. 11a.

FIG. 13 is a detail perspective view of the interaction between a floor panel of the drying floor and the right side wall of the trailer body of FIG. 2 before installation of an adjacent floor panel and taken from detail 13 of FIG. 7.

FIG. 14 is a detail perspective view of the interaction between two floor panels of the drying floor and the side wall of the trailer body of FIG. 5 after installation of the floor panel.

FIG. 15 is a perspective view of a floor panel of the drying floor of the trailer body of FIG. 5.

FIG. 16 is a perspective view of the floor panel of FIG. 15 with the floor panel in an inverted position.

FIG. 17 is a bottom view of the floor panel of FIG. 15.

FIG. 18a is a detail bottom view of a mounting flange of the floor panel of FIG. 15 taken from detail 18 in FIG. 17.

FIG. 18b is a detail bottom view of another embodiment of a floor panel taken from detail 18 in FIG. 17.

FIG. 19 is a detailed bottom view of another embodiment of a floor panel.

FIG. 20 is a perspective view of the trailer body of FIG. 5 with the drying floor and a left side wall removed.

FIG. 21 is a detail perspective view of a rear lower portion of the trailer body of FIG. 5.

FIG. 22 is a perspective view of a truss of the truss of FIG. 11b.

### DETAILED DESCRIPTION

Disclosed is a drying trailer and associated methods, systems, devices, and various apparatus. The drying trailer includes a trailer body, a truss, and a floor panel in various embodiments. It would be understood by one of skill in the art that the disclosed drying trailer is described in but a few exemplary embodiments among many. No particular terminology or description should be considered limiting on the disclosure or the scope of any claims issuing therefrom.

To simplify the description of various elements disclosed herein, the conventions of left, right, front, rear, upper, lower, inside, outside, inboard and/or outboard may be referenced. Unless stated otherwise here or in the figures, “front” describes that end of the drying trailer containing an air inlet or side of any component or other feature of the drying trailer that is facing or is nearest a front of the drying trailer; “rear” is that end of the drying trailer that is opposite or distal the front; “left” is that which is to the left of or facing left from a person standing inside the drying trailer and facing towards the front of the drying trailer; and “right” is that which is to the right of or facing right from a person standing inside the drying trailer and facing towards the front of the drying trailer.

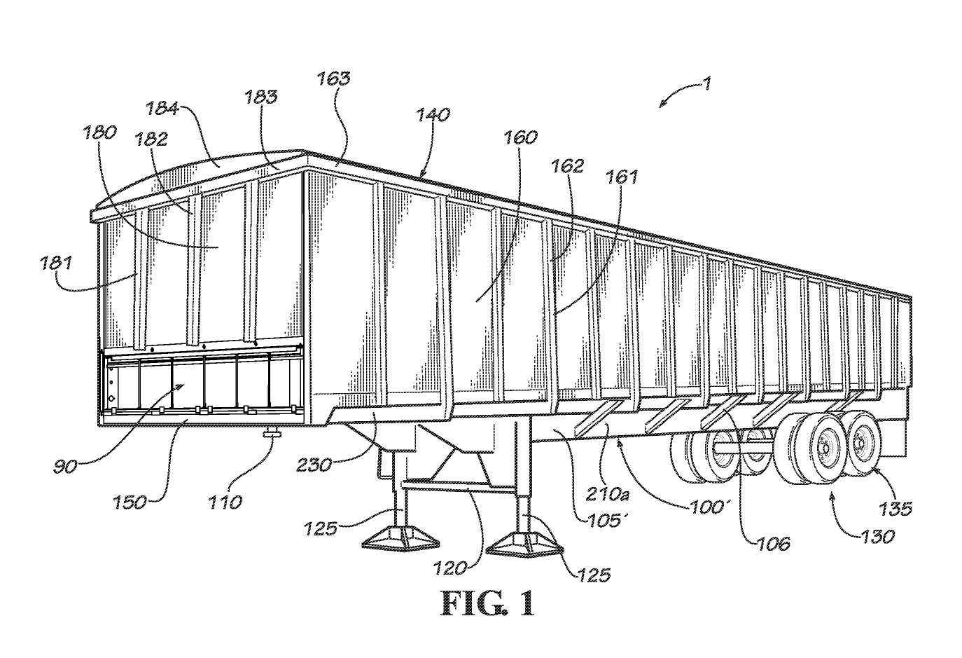

One embodiment of a drying trailer 1 is disclosed and described in FIG. 1, which shows a perspective view of the drying trailer 1 with a chassis frame that is attachable to a truck. In various embodiments, drying trailer 1 includes chassis 100′ and trailer body 140, which may be attached integrally to each other in various embodiments or may be detachable from each other in various other embodiments as described below. In various embodiments, drying trailer 1 does not include a chassis 100′ and is adapted for transport as such through other means including but not limited to railroad cars including well cars, stack cars, or double-stack cars designed for carrying shipping containers, also known as intermodal containers. Drying trailer 1, with or without a chassis 100′, is adapted for transport from one location to another using cranes, conveyors, tracks, or other types of vehicles. In various embodiments of drying trailer using a chassis, chassis 100′ includes chassis frame 105′, landing gear 120, wheel assembly 130, and king pin 110. In various embodiments, chassis frame 105′ includes a plurality of support braces 106. In various other embodiments, support braces 106 are not present.

Landing gear 120 of chassis 100,100′ includes landing gear legs 125, separated from each other in various embodiments but joined in various other embodiments. Wheel assembly 130 includes at least two wheels 135, at least one axle, and various other components, some of which are shown in FIG. 1. Various other systems or subsystems may also be included in drying trailer 1, including but not limited to an electrical system including a lighting subsystem and controls subsystem, a braking system, a suspension system, a pneumatic system, and a hydraulic system, one or more of which in various embodiments coordinates with or support one or more of the other systems and would be familiar to one having ordinary skill in the art but are not explicitly described in detail here.

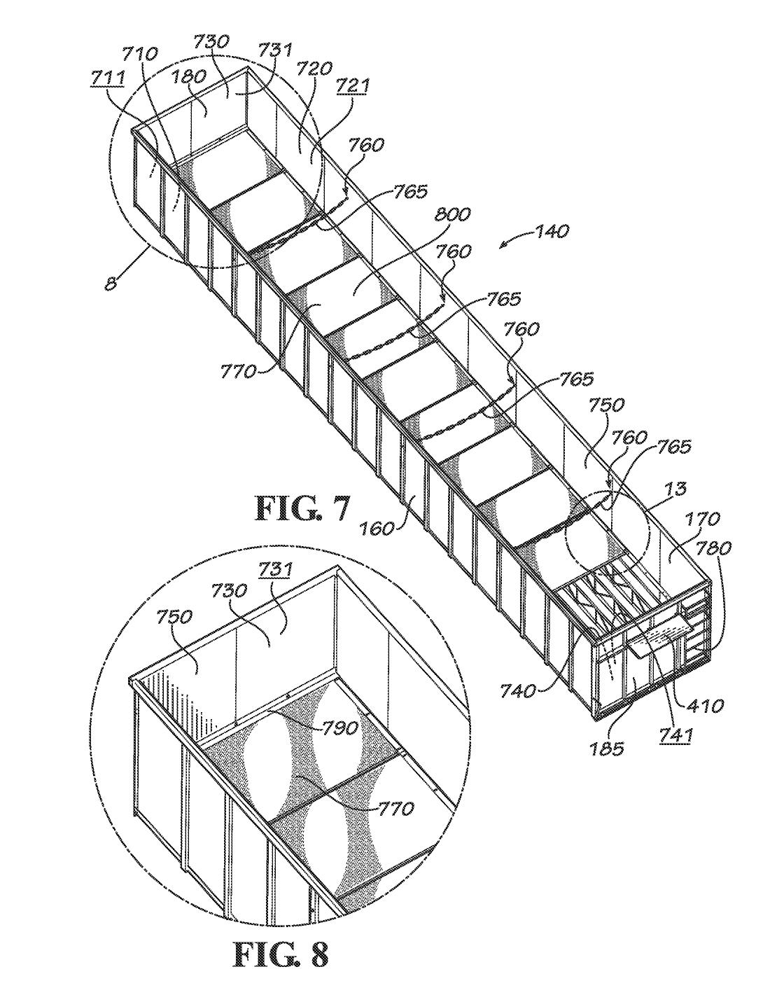

In various embodiments, trailer body 140 includes lower floor 150, a left side wall 160, a right side wall 170 (shown in FIG. 5), a front wall 180, a rear gate 185 (shown in FIG. 7), and a cover 200 (not shown). Lower floor 150, left side wall 160, right side wall 170, and front wall 180 together define air inlet opening 90 at the front of trailer body 140. In various embodiments, an air inlet door (not shown) closes up air inlet opening 90. The air inlet door in various embodiments attaches to trailer body 140 with fasteners (not shown) including but not limited to one or more bolts, screws, or latches; alternatively, a door frame held in place with one or more fasteners including but not limited to rivets, screws, bolts allows the air inlet door to be slid into place from a side, top, or bottom of the air inlet opening. In various embodiments, the air inlet door hingedly attaches to trailer body 140. In various embodiments, the air inlet door removably attaches to the trailer body 140 through other methods. The disclosed configuration of an air inlet door should not be considered limiting on the current disclosure.

In various embodiments, left side wall 160, right side wall 170, front wall 180, rear gate 185, and lower floor 150 are formed from a rigid frame covered with a separate skin including an inside wall surface (disclosed below). Accordingly, left side wall 160 includes frame 161, which in various embodiments includes vertical frame members 162 and at least one horizontal frame member 163. Similarly, right side wall 170 (shown in FIG. 5) includes frame 171, which in various embodiments includes vertical frame members 172 and at least horizontal frame member 173. Front wall 180 includes frame 181, which in various embodiments includes vertical frame members 182, at least one horizontal frame member 183, and top frame member 184. Rear gate 185 (shown in FIG. 7) includes lower gate 190 and upper gate 195. Lower gate 190 includes frame 191, which in various embodiments includes vertical frame members 192 and at least one horizontal frame member 193. Upper gate 195 includes frame 196, which in various embodiments includes vertical frame members 197, at least one horizontal frame member 198, and top frame member 199. In various embodiments, top frame member 184 of front wall 180 and top frame member 199 of upper gate 195 is not present.

In various embodiments where a cover is present, cover 200 includes a plurality of cover supports (not shown) and a cover panel (not shown). In various embodiments, the cover panel is made from one or more lightweight materials including, but not limited to, canvas, plastic, wood, metal, or composite materials. In various embodiments utilizing a cover panel made from a flexible material such as canvas or plastic sheet, cover supports span the distance between the left wall 160 and the right wall 170, and it is against these cover supports that the cover panel can be made taut through a number of various fastening means including but not limited to snaps, ropes, bungee cords, grommets/hooks, bolts, slides, chains, rods, magnets, or simply the weight or shape or other features of the cover itself. In various embodiments, the cover support includes a narrow rod, pipe, bar, or channel with an upward bow substantially matching the curvature of the top of top frame member 184 of front wall 180 and the top of top frame member 199 of upper gate 195. In various embodiments, each cover support also includes a connection portion on each end to attach the cover supports to the trailer body 140. In various embodiments, the cross-sectional or overall shape and orientation and material of the cover supports and the size and material of the cover panel is determined such that the cover, when in place, sheds rain and other precipitation but at the same time allows adequate release of moisture from the product being dried, from inside the drying trailer 1 to outside the drying trailer 1. In various embodiments illustrating this feature, cover supports are made as narrow or as thick or wide as necessary to support the weight of the cover panel which varies by material type, thickness and size.

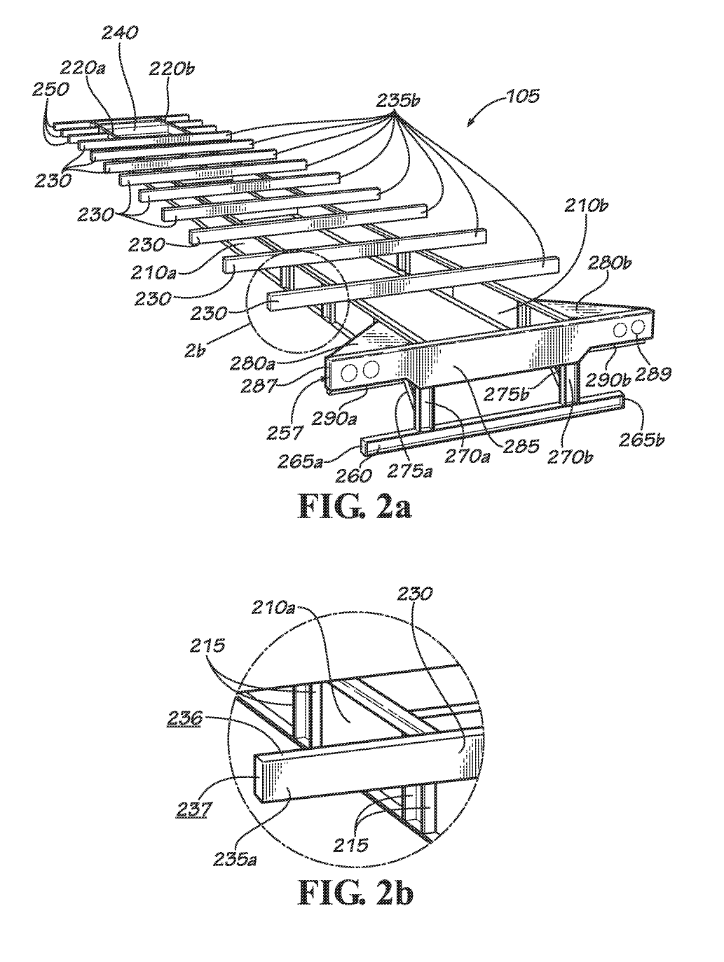

FIG. 2a discloses chassis frame 105 of another embodiment of a chassis. In various embodiments, chassis frame 105,105′ includes two main beams 210a,b and a plurality of cross beams 230. In various embodiments, chassis frame 105,105′ further includes at least one king pin cross beam 240, a plurality of outer cross beams 250, a king pin plate 255, two offset tubes 220a,b, and a bumper frame 257. Offset tubes 220a,b are attached to main beams 210a,b by overlapping the rear end of offset tube 220a with the corresponding front end of main beam 210a and overlapping the rear end of offset tube 220b with the corresponding main beam 210b and then securing each of the offset tubes 220a,b to the corresponding main beams 210a,b through the use of fasteners including but not limited to weldments (not shown) and bolts (not shown) and in various embodiments also utilizing offset strap 221a,b. In various embodiments, a combination of additional straps or splice plates or brackets (not shown) are utilized to create a chassis frame 105,105′ having varying degrees of mechanical rigidity or improved manufacturability. In various embodiments, splice plates or brackets are not utilized but instead the individual components of the chassis frame 105,105′ are welded directly to each other.

Bumper frame 257, shown as part of chassis frame 105,105′ in the current embodiment, includes a bumper 260, rear gussets 280a,b, a tail light cap 285, and mud flap brackets 290a,b. In various embodiments, bumper 260 includes bumper caps 265a,b, bumper hanger 270a,b, and bumper bracket 275a,b. Tail light cap 285 is shown with cap cover 287 and tail light cutouts 289.

Also disclosed is a chassis that is separable from the body in various embodiments. By use of “twistlocks” or similar commercially-available connectors (size and position of which are defined in international standard ISO 1161:1984, for example), trailer body 140 of a separable drying trailer (not shown) can be transferred from one separable chassis to another. Such a drying trailer (which could also be described as a drying container) could also be transferred to and from a separable chassis to and from a stationary mounting location and even stored vertically in a stacked arrangement as is done in rail and ship transport. In these various embodiments, the twistlocks (not shown) are incorporated to or positioned on chassis frame 105,105′ and matching corner castings (not shown) are incorporated into trailer body 140 (or vice versa) so that the drying trailer can be more easily shipped over both land and sea and so that a chassis is not necessarily required for every separable drying trailer but rather one separable chassis can be used to move more than one separable drying trailer composed of everything but the separable chassis.

FIG. 2b is a detail perspective view of the chassis frame 105 of FIG. 2a as shown by detail 2b in FIG. 2a. Cross beam 230 defines beam end 235, top surface 236, and end surface 237. In various embodiments, end surface 237 is not present and therefore cross beam 230 has an opening at one or both ends. In various embodiments, the chassis 100,100′ and trailer body 140 are separable by rotating each of a plurality of the aforementioned twistlocks or twistlock fittings and mechanically separating trailer body 140 from chassis 100,100′. Also disclosed in FIG. 2b are stiffeners 215, attached to main beams 210a,b in order to create a more rigid structure. In various embodiments, stiffeners 215 are located where wheel assembly 130 is attached to chassis frame 105,105′. In various embodiments, stiffeners 215 are also located in other locations such as where landing gear 120 is attached to chassis frame 105,105′.

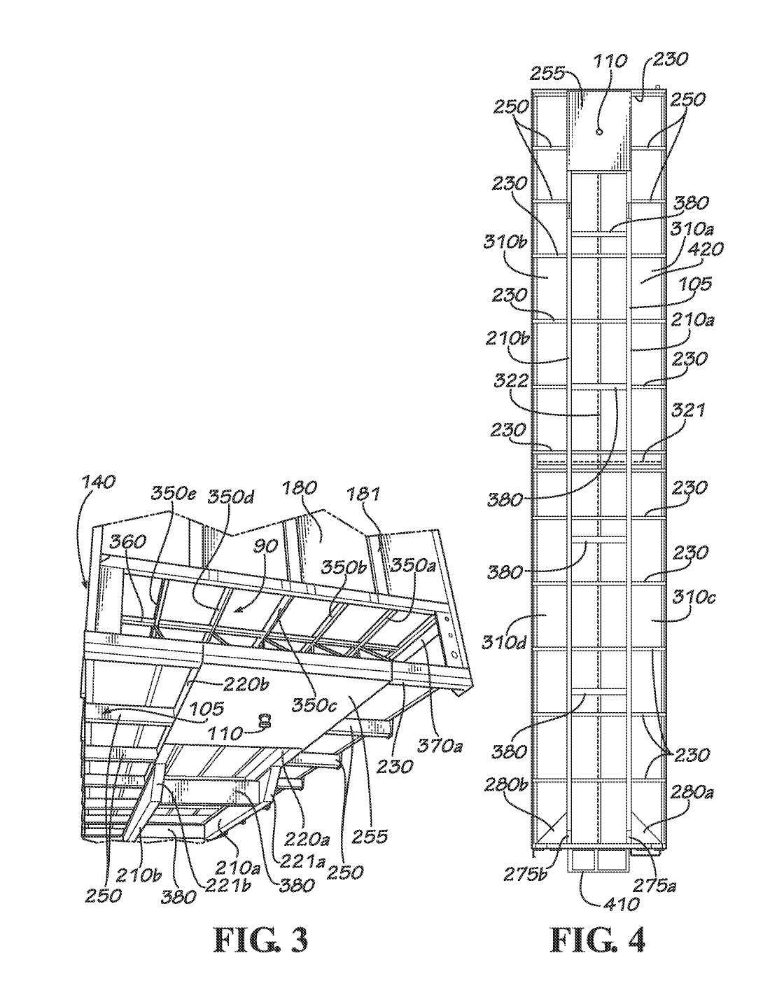

FIG. 3 is a perspective bottom view of the chassis frame 105 of FIG. 2a assembled to a trailer body 140 of the drying trailer 1 of FIG. 1. In the current embodiments of trailer body 140 and chassis frame 105,105′, chassis frame 105,105′ is welded to trailer body 140 such that chassis frame 105,105′ and trailer body 140 reinforce each other with a minimal amount of steel. In various embodiments of the assembled trailer body 140 and chassis frame 105,105′, top surface 236 of cross beams 230 are brought into mating contact with trailer body 140 and the chassis frame 105,105′ and trailer body 140 are welded together in a plurality of locations distributed throughout the interface between chassis frame 105,105′ and trailer body 140. King pin 110, attached to king pin plate 255 at the front bottom portion of chassis frame 105,105′, is of a standard size for coupling with an “eighteen-wheeler” or similar tractor or a 5^{th}-wheel dolly adapted to transport similar trailers. In various embodiments, king pin 110 is adapted to accept a king pin lock (not shown) in order to prevent unauthorized persons from coupling to and transporting drying trailer 1. In addition, stiffening beams 380 are shown spaced at intervals between main beam 210a and main beam 210b to provide additional stiffness to chassis frame 105,105′.

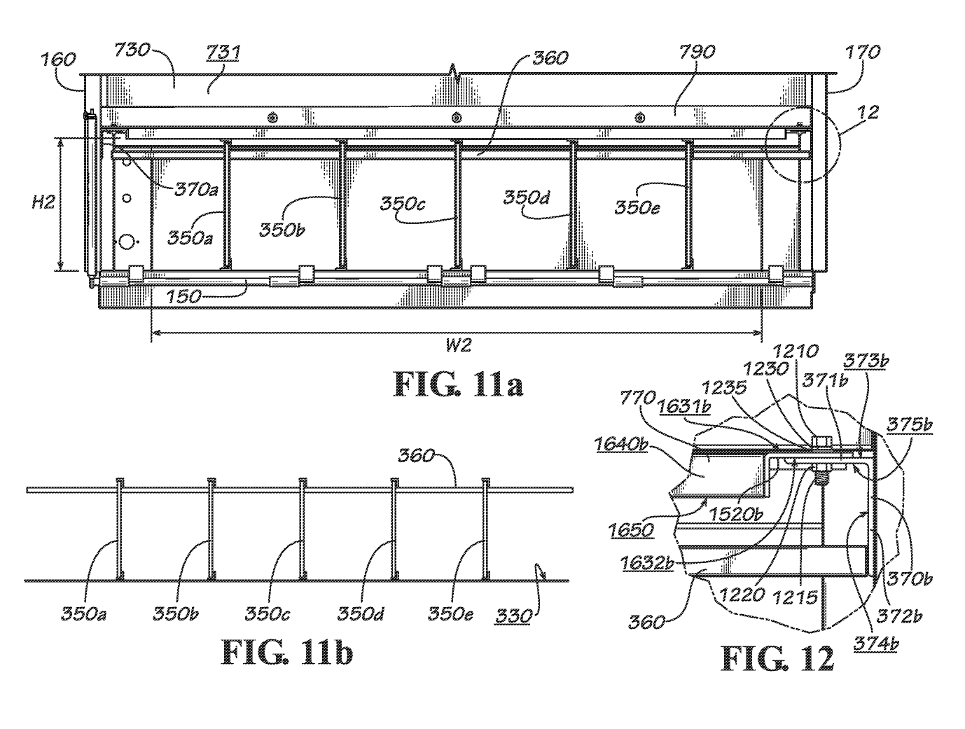

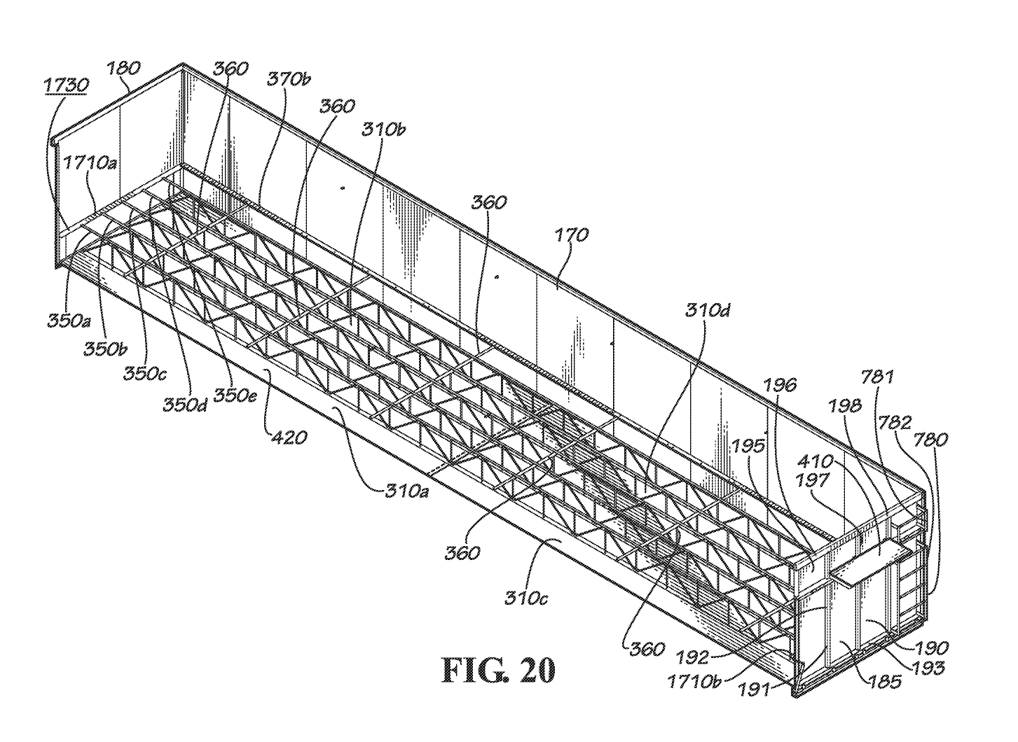

Also disclosed in FIG. 3 are trusses 350a-d, truss tie 360, and side supports 370a,b (370b shown in FIG. 11a), part of an elevated flooring system inside trailer body 140 which includes a floor support structure and a drying floor and which are described in more detail below. In the current embodiment, side supports 370a,b are L-shaped rails that are fixably attached to the side walls of the trailer body. In various other embodiments, side supports 370a,b do not have an L-shaped cross-section or are not a rail per se. Side supports 370a,b are extruded rails in the current embodiment but are constructed by other methods in various embodiments. In various embodiments, side supports 370a,b, instead of being rails, are another set of elements protruding from the side walls including, but not limited to, shelves, flanges, bolts, pins, bosses, and other formed portions of the side walls. As such, side supports 370a,b may be integral to the side walls in various embodiments. Truss ties 360 (a plurality of which are shown in FIG. 20), together with the welds that secure them to trusses 350a-d where truss ties 360 intersect each of trusses 350a-d and to side supports 370a,b, reinforce trusses 350a-d so that they remain vertical. In the current embodiment, five trusses 350a-d, six truss ties 360, and two side supports 370a,b are present in trailer body 140. In various other embodiments, the number of trusses 350, truss ties 360, and side supports 370 may be different based on the size of the drying trailer 1, the weight of the material being dried, and other factors, and the disclosed numbers should not be considered limiting on the current disclosure.

FIG. 4 is a bottom view of an assembly of trailer body 140 and chassis frame 105 shown in FIG. 3. In addition to several aforementioned elements, FIG. 4 discloses a plurality of trailer floor panels 310 that together make up the trailer floor 420 in various embodiments. In various embodiments, drying trailer 1 is constructed with a plurality of trailer floor panels 310 because of the size of each, the availability of raw material, manufacturability, and other factors. In various other embodiments, trailer floor 420 is made from more than four or fewer than four separate trailer floor panels 310, and the number of trailer floor panels 310 should not be considered limiting on the current disclosure. In the current embodiment utilizing four trailer floor panels 310, a longitudinal seam 322 is formed when trailer floor panel 310a is joined with trailer floor panel 310b and when trailer floor panel 310c is joined with trailer floor panel 310d such that an overlapping joint, sometimes referred to as a lap joint, is created and secured via welding or other fastening methods. In the current embodiment utilizing four trailer floor panels 310, a transverse seam 321 is formed when trailer floor panel 310a is joined with trailer floor panel 310c and when trailer floor panel 310b is joined with trailer floor panel 310d such that an overlapping joint, sometimes referred to as a lap joint, is created in a longitudinal direction. In the current embodiment, a longitudinal seam 322 is also formed when trailer floor panel 310a is joined with trailer floor panel 310b and when trailer floor panel 310c is joined with trailer floor panel 310d such that an overlapping joint, sometimes referred to as a lap joint, is created in a transverse direction.

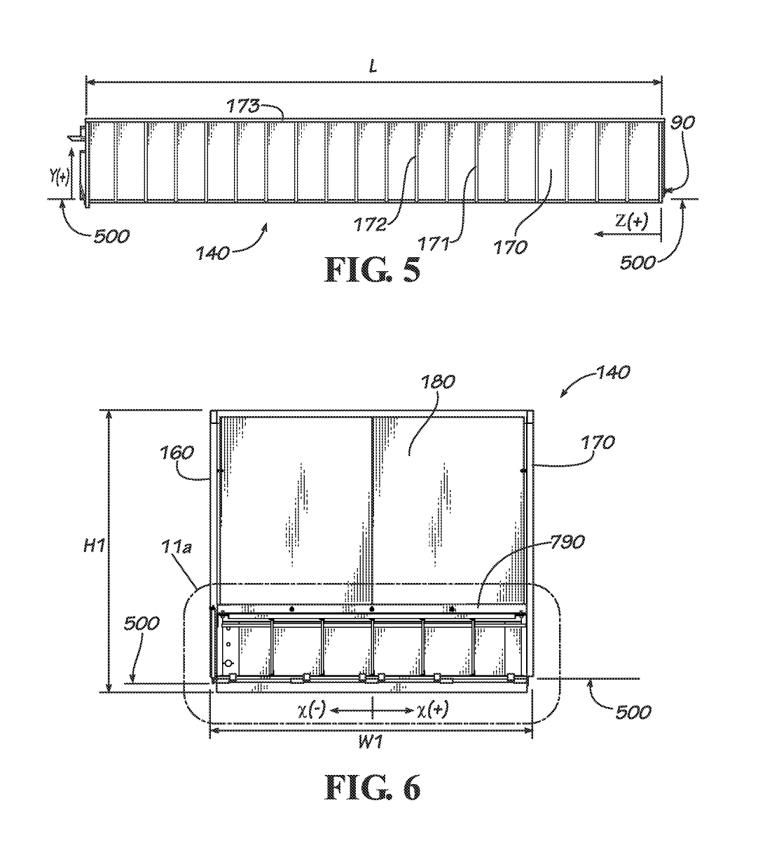

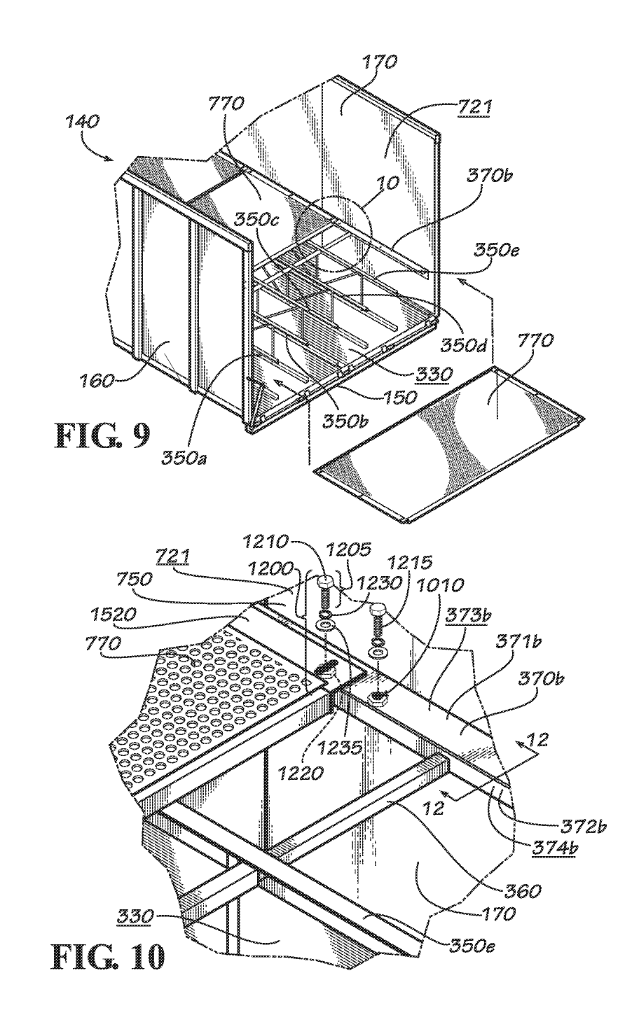

FIG. 5 is a side view of the trailer body 140 of the drying trailer 1. FIG. 5 discloses the right side wall 170. Right side wall 170 is shown with the frame 171, the vertical frame members 172, and the at least one horizontal frame member 173. Horizontal plane 500 proximate to and parallel to a lower floor 150 of trailer body 140 represents a plane with respect to which the lower floor 150—and as a result the rest of the trailer body 140 of drying trailer 1—tend to remain aligned due to its design in the current embodiment. In other words, the stiffness of trailer body 140, as a result of its particular construction, are increased such that a mounting surface 330 (shown in FIG. 9) of lower floor 150 as measured at various points distributed in the Z direction and X direction (shown in FIG. 6) and across lower floor 150 remain in substantially the same plane and therefore not flex or bow in the Y direction. Because the drying trailer 1 in various embodiments is designed to bear a weight of the material to be dried that is as much as 25 tons or more in various embodiments, stiffness of trailer body 140 and of drying trailer 1 of which it is a part in various embodiments can prove advantageous for its functionality and durability. As previously noted, in various embodiments it is trailer body 140 itself that can constitute drying trailer 1. In addition, the presence of trusses 350a-e in drying trailer 1 even after floor panels 770 are removed effectively lowers the effective center of gravity of the trailer. In various embodiments, this can be advantageous considering the height and weight of material to be transported in the drying trailer 1. A lower center of gravity, lowered also by the lower aspect ratio discussed below, increases the stability or capacity of the drying trailer 1.

FIG. 6 is a rear view of the trailer body 140 with the rear gate 185 removed. Height H1 and width W1 represent the overall height and width, respectively, of trailer body 140. As shown in FIG. 6, in various embodiments the ratio which could be described as the aspect ratio of the overall height H1 of trailer body 140 to the overall width W1 of trailer body 140 is less than 1.0. A lower aspect ratio, for example when H1 equals seven feet and W1 equals eight feet in the current embodiment, increases the stability of trailer body 140 and reduce the tendency of trailer body 140 and drying trailer 1 to tip because of top-heaviness, including when drying trailer 1 incorporates a chassis 100′ as illustrated in FIG. 1. The user may tend to fill drying trailer 1 with as much granular material as physically possible without fully grasping the impact which the top-heavy load may have on safe handling or transport of the load. In various embodiments, the aspect ratio is approximately in the range of 0.8 to 0.9. In various other embodiments, the aspect ratio is outside this range. It is not uncommon for a commercially-available trailer body—including that of the drying trailer variety—to have an aspect ratio of 1.0 to 1.5. In comparison to a typical commercially-available trailer, width W1 is increased and H1 is decreased in order to achieve the lower aspect ratio. In various other embodiments, height H1 or W1 are smaller or greater than the figures disclosed above, and the figures disclosed should not be considered limiting on the current disclosure.

FIG. 7 is a perspective top view of trailer body 140. Disclosed is left side wall 160, right side wall 170, front wall 180, and rear gate 185. Left side wall 160 includes inside wall 710, and inside wall 710 defines inside wall surface 711. Right side wall 170 includes inside wall 720, and inside wall 720 defines inside wall surface 721. Front wall 180 includes inside wall 730, and inside wall 730 defines inside wall surface 731. Each of side walls 160,170, front wall 180, and rear gate 185 include wall panels 750 which may vary in size to provide full coverage of each wall. Rear gate 185 includes inside wall 740, and inside wall 740 defines inside wall surface 741. In various embodiments, rear gate 185 includes ladder assembly 780 and platform 410. In various embodiments, left side wall 160 and right side wall 170 include a plurality of eyebolts 760 which are secured to and the “eye” of which in each location is protruding from the left side wall 160 or right side wall 170 to provide a point of attachment for a chain 765 or similar tensile-load-carrying member that helps prevent any outward bowing of left side wall 160 and right side wall 170. In various embodiments, however, the “eye” of one or more of eyebolts 760 does not protrude from left side wall 160 or right side wall 170. In various embodiments, a plurality of floor panels 770 are installed on top of a floor structure incorporating the aforementioned trusses 350a-e, side supports 370a-b, truss ties 360, and other structure. In various embodiments, the drying floor 800 created by floor panels 770 supports the weight of material placed above it inside the drying trailer 1 while at the same time allowing air that enters trailer body 140 of drying trailer 1 through air inlet opening 90 to circulate under and up through floor panels 770 due to the perforated sheet 1505 (shown in FIG. 14) defining a plurality of openings in each floor panel 770. In various embodiments, the floor panels 770 are sized to be carried by a single person. In various embodiments, some or all of the floor panels 770 are removable and an air inlet door (not shown) covers air inlet opening 90 so that the user is able to fill drying trailer 1 with a greater amount of material for the purpose of transporting that material.

FIG. 8 is a detail perspective top view of trailer body 140 taken from detail 8 in FIG. 7 and disclosing upper angle 790. Upper angle 790, secured to front wall 180 in various embodiments, bridges any gap between front wall 180 and the edge of the front edge of the floor panel 770 that is closest to front wall 180.

FIG. 9 is a perspective view of a rear portion of the trailer body 140 with one of the plurality of floor panels 770 and rear gate 185 removed for clarity. Shown secured to mounting surface 330 of trailer floor 420 of lower floor 150 are the trusses 350a-d, spaced at intervals between left side wall 160 and right side wall 170. FIG. 9 also shows side support 370b attached to wall surface 721 of right side wall 170. In the current embodiment, a 48-foot drying trailer application, there are twelve floor panels making up drying floor 800. In various other embodiments, there are fewer panels or more panels varying based on the size of the trailer (especially length and width) and based on the desired maximum weight of each panel. Drying trailers shorter than 48 feet in length and having a different overall height H1 or a different overall width W1 are considered part of the present disclosure. Two shorter drying trailers, as long as 28.5 feet or longer and sometimes referred to as “doubles,” could also be built to trail together behind a single tractor, using a converter gear or “dolly” to support the second drying trailer and to connect the second drying trailer to the first drying trailer. Trailers longer than 48 feet in length having a different overall height H1 or a different overall width W1, while also considered part of the present disclosure, may have limited practicality beyond 53 feet in length or whatever is the maximum length for a trailer under the applicable transportation regulations in effect at the time. Other sizes and shapes are conceivable for markets outside the U.S. using the same disclosed structure.

FIG. 10 is a detail perspective view of trailer body 140 taken from detail 10 of FIG. 9. Showing the structure below and around each floor panel 770, FIG. 10 discloses side support 370b attached to wall surface 721 of right side wall 170 and shows several of the individual components making up side supports 370a,b (370a shown in FIG. 11a). Side support 370a includes horizontal legs 371a and vertical leg 372a. Horizontal leg 371a (shown in FIG. 11a) of side support 370a includes top surface 373a (not shown), and vertical leg 372a (not shown) includes inboard surface 374a (not shown). Side support 370b includes horizontal legs 371b and vertical leg 372b. Horizontal leg 371b of side support 370b includes top surface 373b, and vertical leg 372b (not shown) includes inboard surface 374b (not shown). When installed as shown in FIG. 10 so that material can be placed in drying trailer 1 for drying, the lowest portion of each of the floor panels 770 rests on top of trusses 350a-e shown, and the end of each floor panel 770 that is closest to the wall surface 711 of left side wall 160 to which side support 370a is attached rests on top surface 373a of horizontal leg 371a of side support 370a. The end of each floor panel 770 that is closest to the wall surface 721 of right side wall 170 to which side support 370b is attached rests on top surface 373b of horizontal leg 371b of side support 370b. In various embodiments, side supports 370a,b define a plurality of holes 1010 for securing floor panels 770. In various embodiments, a fastener 1200 will be installed in holes 1010 to secure floor panels 770 as described below. FIG. 10 also shows truss tie 360 connected to both truss 350e and side support 370b at inboard surface 374b of vertical leg 372b, including by welding in various embodiments.

FIG. 11a is a detail rear view of the lower portion of trailer body 140 taken from detail 11a in FIG. 6. As previously described, lower floor 150, left side wall 160, right side wall 170, and front wall 180 together define air inlet opening 90 at the front of trailer body 140, and an air inlet door (not shown) closes up air inlet opening 90 in various embodiments. Air inlet opening 90 has a height H2, substantially equivalent to the height of trusses 350a-e, and it has a width W2. In the current embodiment, H2 is approximately 18 inches and W2 is approximately 80 to 84 inches or approximately seven feet. While the lowest portion of floor panels 770 is shown in contact with the top of trusses 350a-e, it is not necessary to secure the floor panels 770 to any portion of trusses 350a-e to prevent racking or buckling of trusses 350a-e because trusses 350a-e are independently supported directly through truss ties 360 and indirectly through side supports 370a,b and ultimately by side walls 160,170. The independent attachment and reinforcement of trusses 350a-e makes is possible in various embodiments to remove floor panels 770 entirely without removing the other structural parts of trailer body 140.

FIG. 11b is a detail rear view of a truss of the lower portion of trailer body 140. Shown here is the interaction between the trusses 350a-e, truss ties 360, and trailer floor 330 of lower floor 150 with the other surrounding parts removed.

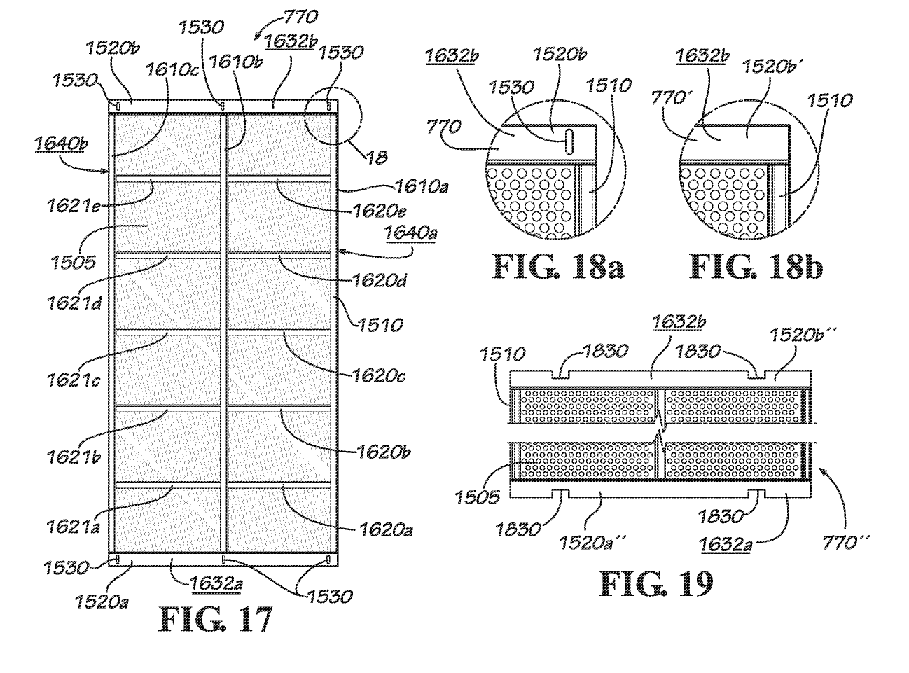

FIG. 12 is a detail sectional view of the interaction between drying floor 800 and right side wall 170 of trailer body 140. Mounting surface 1632b of mounting flange 1520b of floor panel 770 is shown in an installed condition in mating contact with top surface 373b of horizontal leg 371b of side support 370b. In addition, truss tie 360 is shown connected to inboard surface 374b of vertical leg 372b of side support 370b. Also shown is one embodiment of a fastener 1200 for securing floor panels 770 to side supports 370a,b. A nut 1220 of fastener 1200 is positioned on the underside of horizontal leg 371b of side support 370b. In various embodiments, one axial end of nut 1220 of fastener 1200 is fixably attached to the bottom surface 375b of horizontal leg 371b of side support 370b. In various embodiments, nut 1220 is welded to the bottom surface 375b of horizontal leg 371b of side support 370b. In various embodiments, a shaft 1215 of a bolt 1205 of fastener 1200 is sized to fit through the corresponding mounting slots 1530 (shown in FIG. 17) in floor panels 770, and engage nut 1220, locking that portion of floor panel 770 in place.

In various embodiments, a lock washer 1230 and a flat washer 1235 are positioned between nut 1220 and bolt 1205 in one or more instances of fastener 1200. In various embodiments, a lock washer 1230 and a flat washer 1235 are positioned between surface 1631 of mounting flange 1520 floor panel 770 and a head 1210 of bolt 1205 of fastener 1200. In various embodiments, the use of lock washer 1230 and flat washer 1235 gives at least a visual indication to the user that bolt installation torque has reached a predetermined level. In various embodiments, the installation torque of fasteners 1200 keeps floor panels 770 in place when using drying trailer 100 in various applications.

In various embodiments, the fasteners 1200 include a plurality of nuts 1220 fixably attached to the bottom surface 375b of horizontal leg 371b of side support 370b. Also in various embodiments, fasteners 1200 include a plurality of bolts 1205 with shaft 1215 extending downward through a plurality of mounting slots 1530 in the drying floor 800 when the drying floor 800 is fastened to the side supports 370a,b, wherein each bolt 1205 is sized to hold captive the floor panel 770 when installed in a corresponding nut 1220 through the floor panel 770. In various embodiments, bolt 1205 or even fastener 1200 is not necessary as the floor panel 770 is secured by other means. In various embodiments, a fastener 1200 or any portion thereof is not necessary because the user of drying trailer 1 does not require the floor panels 770 to be secured because gravity holds them down to trusses 350 and side supports 370a,b sufficiently.

In various embodiments, fastener 1200 includes bolt 1205 and nut 1220; however, head 1210 of bolt 1205 is fixably attached to the underside of horizontal leg 371b of side support 370b. In various embodiments, head 1210 of bolt 1205 is welded to the bottom surface 375b of horizontal leg 371b of side support 370b such that shaft 1215, threaded in various embodiments, of bolt 1205 is extending up and through hole 1010 of side support 370b and mounting slot 1530 of floor panel 770.

In various embodiments, a plurality of bolts 1205, each with shaft 1215 above head 1210, are fixably attached to the underside of support 370b such that they extend upward through hole 1010 of side support 370b and through a plurality of mounting slots 1530 in floor panels 770 of drying floor 800 when the drying floor 800 is fastened to the side supports 370a,b. In various embodiments, the plurality of bolts 1205 will be welded to the underside of support 370b. In various embodiments, nut 1220 is sized to hold captive the floor panel 770 when installed on a corresponding bolt 1200 extending through the floor panel 770. In various embodiments, a nut 1220 is not necessary as the floor panel is secured by other means. In various embodiments, a nut 1220 is not necessary because the user of drying trailer 1 does not require the floor panels 770 to be secured because gravity holds them down to trusses 350 and side supports 370a,b sufficiently. In various embodiments, lock washer 1230 or flat washer 1235 are positioned between surface 1631 of mounting flange 1520 floor panel 770 and an axial end of nut 1220 of fastener 1200.

In various embodiments, fastener 1200 has standardized matching screw threads including but not limited to those found on a ⅜-inch diameter bolt. In various other embodiments, either nut 1220 or bolt 1205 or both nut 1220 and bolt 1205 has connecting threads that require fewer rotations during the installation process or have asymmetric features. In various embodiments, each of a fastener 1200 requires only a ninety-degree rotation in order to lock fastener 1200 in place and secure floor panel 770. The disclosure of a particular fastener 1200 should not be considered limiting of the size, shape, threading, orientation, and other features possible for fastener 1200. In various embodiments, the shape of mounting slots 1530 matches the threading of bolt 1205 of fastener 1200.

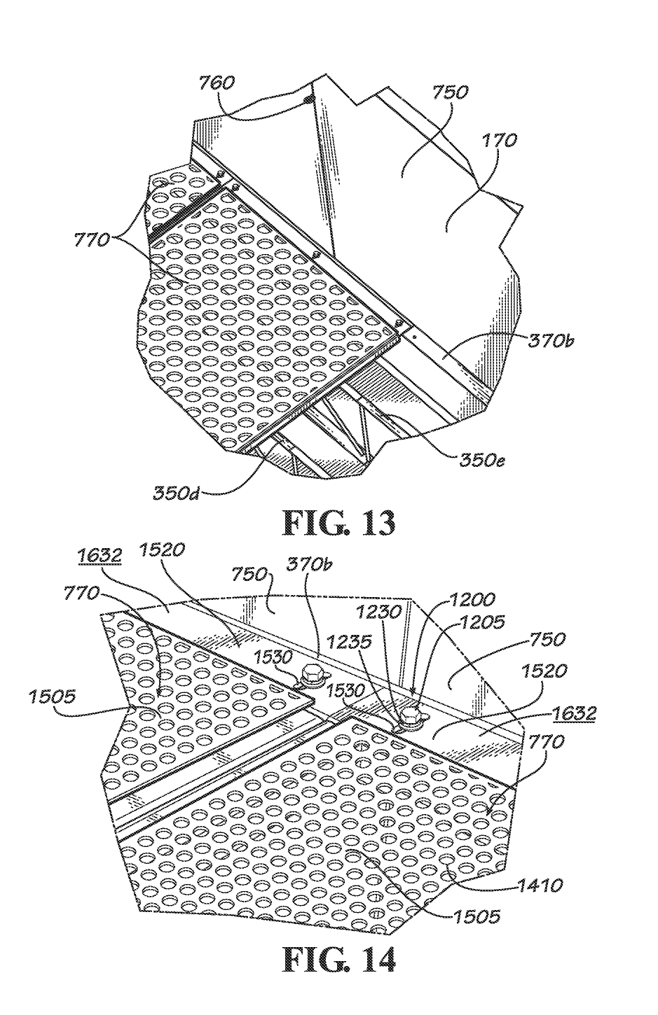

FIG. 13 shows the interaction between one floor panel 770 of the drying floor 800 and the side wall of the trailer body of FIG. 2 in perspective view before installation of a second floor panel 770. Eye bolt 760 is visible as is wall panel 750 of right side wall 170.

FIG. 14 is a detail perspective view of the interaction between a floor panel 770 of drying floor 800 and the right side wall 170 of trailer body 140 after placement but before fastening of the second floor panel 770. Shown also is perforated sheet 1505 affixed to the top of the floor panels 770 shown. In various embodiments, floor panel 770 includes mounting flanges 1520a,b as shown.

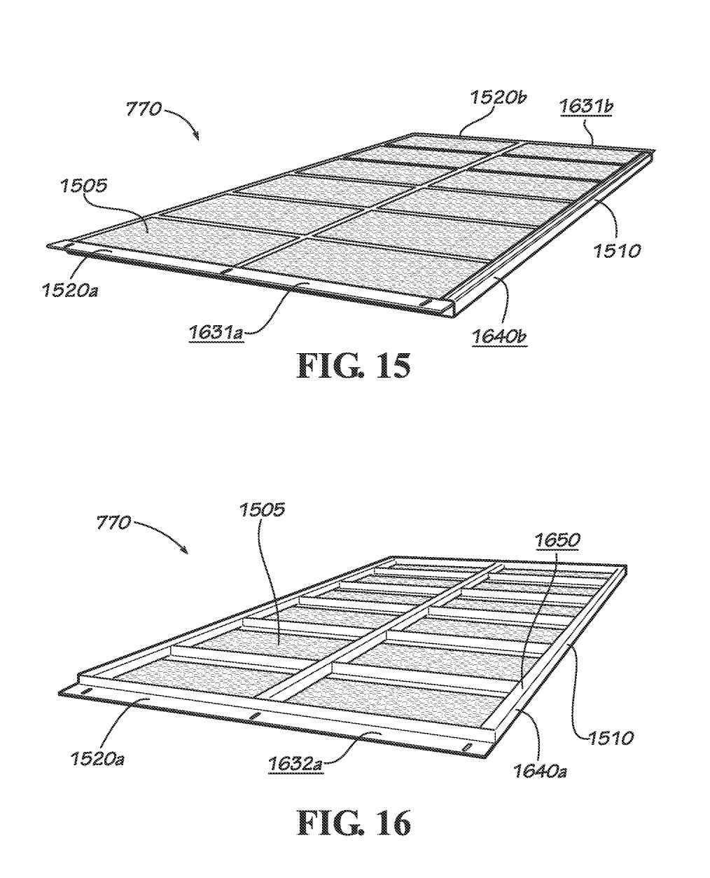

FIG. 15 is a perspective top view of floor panel 770 of drying floor 800 of trailer body 140. Floor panel 770 includes frame 1510 and the aforementioned perforated sheet 1505. In various embodiments, perforated sheet 1505 is made from 18-gage cold-rolled steel flat stock material defining ⅛″ diameter holes or openings 1410 staggered every 3/16″ on center. Openings 1410 of perforated sheet 1505 are circular in various embodiments, but in various other embodiments are of one or more shapes that are not circular including, but not limited to, shapes defined by straight segments or arcuate segments with variable radii or a combination of straight and arcuate segments. Perforated sheet, perforated sheet 1505 in the current embodiment, can be manufactured from any number of different ways including various computer numerically controlled (CNC) punching and various laser-cutting methods. In various other embodiments, perforated sheet 1505 is not made from flat stock from which material is removed but rather expanded metal which in some cases results in less material cost (due to less waste). Other types of material which could conceivably be used include, but are not limited to, metal or non-metal screens including “chicken wire” or other poultry netting if made from sufficiently strong and thick gage wire including sufficiently small and sufficiently shaped openings 1410 so as not to allow passage of the material being dried. Other methods and materials are also contemplated by this disclosure and the disclosure of perforated sheet should not be considered limiting on the current disclosure.

In the current embodiment, the “open area”—effectively the percentage of the surface area of the sheet that allows air passage—is 40 percent. In various other embodiments, the open area is more or less or can vary by a combination of floor panel 770 having differing degrees of open area in perforated sheet 1505. In some applications where the drying trailer is especially long—whether drying is accomplished by ambient air or facilitated by pushing heated air for drying into air inlet opening 90, decreasing resistance to air passage through the floor as the air travels through the trailer and up through the floor through the material being dried may yield more desirable results. More desirable results could include more uniform drying, faster drying, or some other benefit considered by the user of the drying trailer based on ambient conditions, the properties of the material being dried, and other factors. In other applications, increasing resistance to air passage through the floor using panels with decreasing percentages of open area as the air travels through the trailer and up through the floor through the material being dried may yield more desirable results considering the different uses and environments in which the drying trailer could be used. Because the floor panels, floor panels 770 in various embodiments, are removable and replaceable by hand or tools without special equipment, the user is able to set up any one of a number of configurations.

FIG. 16 is a perspective bottom view of floor panel 770. FIG. 17 is a bottom view of the floor panel 770. Various embodiments of floor panel 770, as shown in FIG. 17, include the aforementioned frame 1510 and perforated sheet 1505. In a direction parallel with the long dimension of the panel in FIG. 17 and transverse with respect to trailer, transverse frame members 1610a,b,c connect mounting flange 1520a to mounting flange 1520b. Angle members 1620a-e connect transverse frame members 1610a and 1610b, and angle members 1621a-e connect transverse frame members 1610b and 1610c. In various embodiments, each of the mounting flanges 1520a,b define one or more mounting slots 1530—three mounting slots 1530 in the current embodiment—that adjust for variability in the distance between side support 370a on the left side of drying trailer 1 and side support 370b at the right side of drying trailer 1. In various embodiments of frame 1510, connections between each part are made by welding. In various embodiments of floor panel 770, perforated sheet 1505 is pulled taut and affixed to frame 1510 by welding but may be affixed by other materials and methods including but not limited to mechanical fasteners, adhesive, clamping force, or friction.

FIG. 18a shows a detail bottom view of one corner of floor panel 770 with mounting slot 1530 defined in mounting flange 1520b (1520a similar). FIG. 18b shows a detail bottom view of an embodiment of the mounting flange 1520b′ that includes no mounting slots 1530. In various other embodiments, mounting flanges 1520a,b could be made of a magnetic material or could accept magnetic strip or magnetic tape and therefore fasteners, at least fasteners 1200, would not be necessary. As shown in FIG. 19, a detailed bottom view of another embodiment of the mounting flanges 1520b″ of the floor panel 770, the mounting flanges define notches which serve as fasteners by allowing panel to be lowered into position past protrusions (not shown) on the wall surface 711 and wall surface 721 of the left wall 710 and right wall 720, respectively, protrusions for which the notches provide clearance. After the notches on the mounting flanges 1520b″ of the floor panel 770 clear the protrusions on the walls, panel is free to move for enough forward (or backward) into its intended location so that the notches no longer line up with the protrusions. Each of the other panels can be installed thereafter. Because the notches no longer line up with the protrusions with simply the solid portion of the mounting flanges 1520b″, because of the width in the X direction with respect to the drying trailer 1, and because the other panels have now been installed, none of the panels is allowed to move in X, Y or Z directions (convention shown in FIGS. 5 and 6) are therefore locked in place without fasteners 1200, except as needed to hold upper angle 790 (shown in FIG. 8) at the front of the drying trailer 1 or as needed to hold the corresponding part at the rear of the drying trailer 1, parts which serve to close up the gap between the first and last floor panels 770 and either the front wall 180 or rear gate 185 as appropriate.

FIG. 20 is a perspective view of the trailer body 140 of FIG. 5 with the drying floor 800 and a left side wall 160 removed and disclosing front wall 180, right side wall 170, and rear gate 185. FIG. 20 also discloses trailer floor panels 310, trusses 350a-e, truss ties 360, and side support 370b. In various embodiments, trusses 350a-e are welded to trailer floor panels 310, truss ties 360, side supports 370a,b, and to a front support 1710a and a rear support 1710b. In the current embodiment, front support 1710a and rear support 1710b are L-shaped rails that are fixably attached to the front wall 180 or rear 185 of the trailer body 140. In various other embodiments, front support 1710a and rear support 1710b do not have an L-shaped cross-section or are not rails per se. Front support 1710a and rear support 1710b are extruded rails in the current embodiment but are constructed by other methods in various embodiments. In various embodiments, front support 1710a and rear support 1710b, instead of being rails, are another set of elements protruding from the front or rear walls including, but not limited to, shelves, flanges, bolts, pins, bosses, and other formed portions of the front and rear walls. As such, front support 1710a and rear support 1710b are integral to the front or rear walls in various embodiments. In various embodiments similar to that illustrated by the interaction of floor panels 770 with side supports 370a,b shown in FIG. 12, various portions of bottom surface 1650 (see FIG. 16) of floor panel 770 comes into mating contact with top surface 1730a of front support 1710a and with top surface 1730b of rear support 1710b (not shown). In various embodiments, front support 1710a and rear support 1710b are utilized to also prevent gaps at the front wall 180 and rear wall (not shown) of the trailer body 140 through which material that is being dried or stored is able to fall. In the current embodiment, floor panels are sized and positioned such that a surface 1640a or surface 1640b of each floor panel 770 is mated to a corresponding 1640a or 1640b of an adjacent floor panel 770 to prevent gaps between floor panels 770. Tolerance issues in various embodiments necessitate that a gap is built in which front support 1710a or rear support 1710b closes.

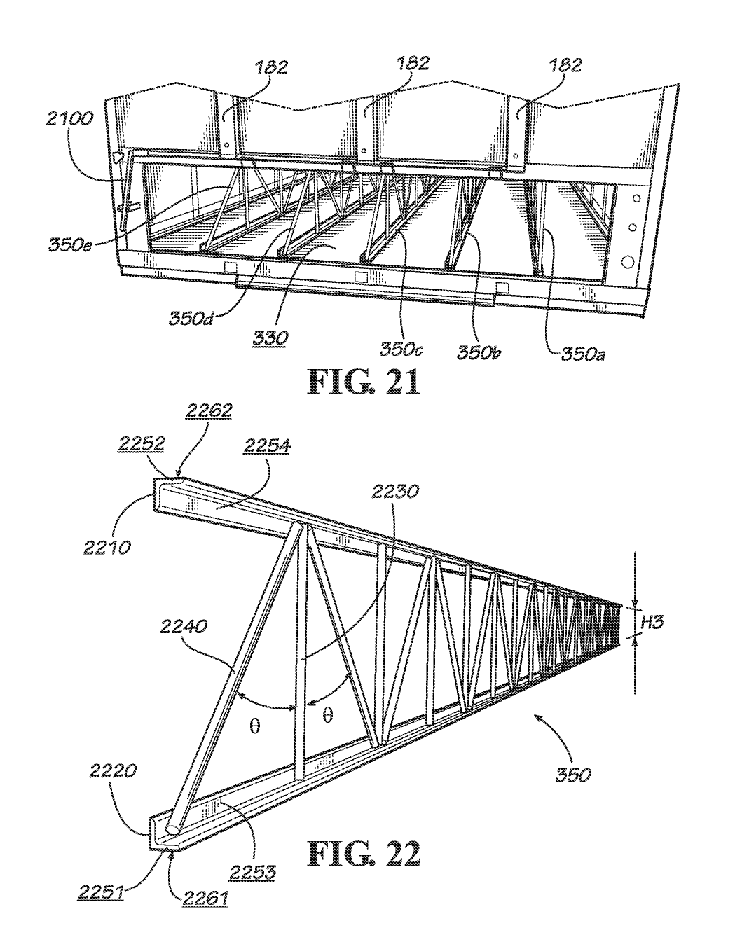

FIG. 21 is a detail perspective view of the rear lower portion of trailer body 140 showing a transition latch 2100 and several other features disclosed previously.

FIG. 22 is a perspective view of truss 350 included in FIG. 11b. Upper angle 2210 and lower angle 2220 are connected by a plurality of vertical truss rods 2230 and a plurality of diagonal truss rods 2240, each set at an angle θ (theta) from the neighboring vertical truss rod 2230 and sized to achieve desired truss height H3 corresponding in various embodiments to air inlet opening height H2. Lower surface 2251 of lower angle 2220 fastens to mounting surface 330 of trailer body 140, while upper surface 2252 of upper angle 2210 comes in contact with the bottom 1650 of each floor panel 770. Vertical truss rods 2230 and diagonal truss rods 2240 are fastened to inside surface 2253 of lower angle 2220 and inner surface 2254 by welding in various embodiments to ensure the strength of the assembled trusses 350.

Unless otherwise specified above, the individual structural components of drying trailer 1 are made from hot-rolled steel or “black steel” in various embodiments and left in an unfinished state. In various other embodiments, the components of drying trailer 1 is made from a material other than hot-rolled steel including, but not limited to, cold-rolled steel, aluminum, and various aluminum alloys. Different levels of corrosion resistance and strength are available through various combinations of different materials and different finishing processes.

The disclosure contemplates the drying of any number of food and non-food items including, but not limited to peanuts, pecans, walnuts, onions, seed corn, almonds, herbs, spices, muscadine and other grapes, beans, pine cones, wood chips, saw palmetto berries, and turf. However, any number of other materials can be conceivably dried using the systems and methods disclosed herein. In the current embodiment, the capacity of the drying trailer 1 by weight of material is 25 tons, though the capacity may be higher or lower in various embodiments and the disclosure of a 25-ton capacity should not be considered limiting on the current disclosure.

Also disclosed is a method of converting the drying trailer 1 from a drying state to a storage state including disconnecting a floor panel 770 from a support 370 within drying trailer 1, moving the floor panel 770 away from the truss 350, and removing the floor panel 770 from an interior of the drying trailer 1 to an exterior of the drying trailer 1. In various embodiments, the drying trailer 1 includes truss 350 and trailer floor 800 including one or more floor panels 770. In various embodiments of the disclosed method, dryer trailer 1 further comprises chassis 100′, the chassis 100′ including the chassis frame 105,105′, the wheel assembly 130, and the landing gear 120. In various embodiments, bottom surface 2261 of each truss 350 is fixably attached to mounting surface 330 defined by trailer body 140 of the drying trailer 1, the floor panels 770 separable from trusses 350. In various embodiments, mounting surface 330 is defined by trailer floor 420. In various embodiments, the method further includes fixably closing the air inlet opening 90. In various embodiments, the method further includes removing floor panels 770 from the support by removing removable fasteners including but not limited to fasteners 1200. In various embodiments, floor panels 770 are removed by lifting. In various embodiments, removable fasteners are not required at all to secure removable floor panels 770. Fixably attaching truss 350 or trusses 350 to mounting surface 330 will include welding in various embodiments. In various other embodiments, welding will be replaced with fasteners, including but not limited to rivets or bolts. In various embodiments, trusses 350 will be incorporated into the lower floor 150 of trailer body 140.

Various embodiments of drying trailer 1 can also be dumped by rotating the trailer body 140 to an angle of 30 degrees from the surface on which drying trailer 1 is supported, although an angle of 30 degrees is not intended to be limiting. To facilitate dumping with this method, the entire rear gate 185 or at least the lower gate 190 of the rear gate 185 hingeably rotates from either an upper edge of the rear gate 185 or from an upper edge of the lower gate 190.

After removal of floor panels 770, floor panels 770 can be stacked vertically or stood on end by using only a minimal amount of floor space. Alternately, floor panels 770 can be removed from their installed position over supports 370 and trusses 350 and stored inside drying trailer 1 by securing to the inside left and right walls using simple brackets (not shown) to hold the rectangular-shaped floor panels 770. In various embodiments, this is an additional advantage of the floor panels 770 and only the floor panels 770 being removable from drying trailer 1 during the conversion process from the drying configuration to the transport configuration.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. An elevated flooring system for use in a drying trailer comprising:
a truss, a bottom surface of the truss fixedly attachable to a trailer floor of the drying trailer;
a drying floor including a floor panel defining openings sized to allow passage of drying air, the floor panel lying on the truss and separable from the truss, the truss sized to elevate the drying floor a spaced distance from the trailer floor; and
a support attachable to a side wall of the drying trailer, the drying floor detachably connected to the support.

2. The system of claim 1, wherein the drying floor is connected to the support with fasteners.

3. The system of claim 2, wherein the fasteners include a plurality of bolts, each bolt including a head and a shaft, the shafts extending from the head of each bolt through a plurality of mounting slots in the drying floor when the drying floor is fastened to the support.

4. The system of claim 2, wherein the fasteners include a plurality of nuts welded to the support.

5. The system of claim 1, wherein the support is a rail.

6. The system of claim 1, further comprising a truss tie, the truss tie secured to the truss.

7. The system of claim 6, wherein the truss tie is secured to the truss by welding.

8. A drying trailer comprising:
a trailer body, the trailer body including a lower floor, a first side wall, a second side wall, and a front wall;
a truss, a bottom surface of the truss fixably attached to the lower floor of the trailer body of the drying trailer;
a floor panel defining a drying floor, the floor panel defining openings sized to allow passage of drying air, the floor panel lying on the truss and separable from the truss, the truss elevating the drying floor a spaced distance from the lower floor, an air circulation cavity defined between the drying floor, the lower floor, the first side wall, and the second side wall.

9. The drying trailer of claim 8, further comprising:
a first support attached to the first side wall; and
a second support attached to the second side wall;
wherein the floor panel is connected to the first support and the second support with fasteners.

10. The drying trailer of claim 9, wherein the fasteners include a plurality of nuts, an axial end of each of the plurality of nuts welded to one of the first support and the second support.

11. The drying trailer of claim 8, further comprising a truss tie, the truss tie secured to the truss.

12. The drying trailer of claim 8, wherein the bottom surface of the truss is welded to the trailer floor of the trailer body of the drying trailer.

13. The drying trailer of claim 9, wherein the floor panel includes a mounting flange, the mounting flange defining at least one mounting slot.

14. The drying trailer of claim 13 further comprising a plurality of bolts, wherein each bolt includes a head and a shaft, each head and each shaft sized to hold captive the floor panel when installed on a corresponding bolt extending through the floor panel.

15. A method of converting a drying trailer from a drying state to a storage state comprising:
disconnecting a floor panel from a support within a drying trailer, the drying trailer having a truss and a trailer floor, the floor panel lying on the truss, the truss sized to elevate the drying floor a spaced distance from the trailer floor; and
moving the floor panel away from the truss; and
removing the floor panel from an interior of the drying trailer to an exterior of the drying trailer.

16. The method of claim 15, wherein the truss is welded to the trailer floor of the drying trailer.

17. The method of claim 15, wherein moving the floor panel away from the truss includes lifting the floor panel.

18. The method of claim 15, whereby disconnecting the floor panel from the support includes disconnecting a fastener.

19. The method of claim 18, wherein the fastener includes a nut and a bolt, the nut welded to the support.

20. The method of claim 15, further comprising:
disconnecting a second floor panel from the support within the drying trailer; and
moving the second floor panel away from the truss.
